(19) United States
(12) Patent Application Publication
(10) Pub. No.: US 2010/0231799 A1
(43) Pub. Date: Sep. 16, 2010

(54) METHOD AND APPARATUS FOR REDUCING COLOR NOISES

(75) Inventors: Min-Yu Lin, Hsinchu City (TW); I-Hong Chen, Taoyuan City (TW); Chung-Yen Lu, Taipei City (TW)

Correspondence Address: SNELL & WILMER L.L.P. (Main), 400 EAST VAN BUREN, ONE ARIZONA CENTER, PHOENIX, AZ, 85004-2202, US

(73) Assignee: MEDIATEK, INC., Hsinchu (TW)

(21) Appl. No.: 12/401,342

(22) Filed: Mar. 10, 2009

(51) Int. Cl. H04N 9/77

(52) U.S. Cl. 348/662; 348/E09.035

(57) ABSTRACT

A method for reducing color noises of a chrominance signal includes the following steps: receiving the chrominance signal; sampling the chrominance signal to generate a plurality of chrominance samples; determining a phase-rotation level between a specific chrominance sample and the chrominance samples; calculating an average value of the chrominance samples; and selectively outputting the average value or the chrominance information of the specific chrominance sample as an output chrominance information to represent the color information of the specific chrominance sample according to the phase-rotation level.

### FIELD OF INVENTION

The invention is related to a composite video signal, and more particularly related to a method and an apparatus for reducing color noises of the composite video signal.

### BACKGROUND OF THE INVENTION

The color television systems, used in Taiwan, the United States, Canada, Japan, South Korea, etc., are based on signal specifications originally defined by the National Television Systems Committee (NTSC). Besides the NTSC systems, the well-known Phase Alternating Line (PAL) systems, used in Mainland China, Germany, North Korea, etc., and Sequential Couleur Avec Mémoire (SECAM) systems, used in France, Iran, Iraq, etc., are other signal specifications developed in the world. These systems utilize composite color television signals. For example, the basics of PAL and the NTSC system are very similar because both of them use a quadrature amplitude modulated sub-carrier (typically at approximately 3.58 MHz for NTSC, and 4.43 MHz for PAL) carrying the chrominance information (C) which is added to the luminance video signal (Y) to form a composite video baseband signal (CVBS). The concept of CVBS, i.e. luminance and chrominance, is framed for early black-and-white television compatibility.

Typically, the signal based on the NTSC system consists of 29.97 video frames per second, and each frame consists of 525 scan lines. The signal based on the PAL system consists of 25 video frames per second, and each frame consists of 625 scan lines. The CVBS can be expressed as: CVBS=Y+C=Y+U*sin(ωt)+V*cos(ωt) in time domain by those skilled in the art, wherein the chrominance contains two components, namely, a hue (U) component and a saturation (V) component. The ω in the expression discussed above is a sub-carrier frequency for modulating the chrominance information.

When a receiver, such as a TV set, receives a composite video baseband signal, the composite video baseband signal could be separated into luminance and chrominance information. A conventional simplified separator 100 is shown in FIG. 1. Referring to the expression stated above, if a composite video baseband signal CVBS passes through a band pass filter (BPF) 102 with its band pass frequency centered at ω, the chrominance information C may be obtained. Next, if subtracting the chrominance information C from the composite video baseband signal CVBS by a saturator 104, the luminance information Y could be obtained. There are still other manners known in the art to separate luminance and chrominance, such as comb filters. However, during the process of separation, color noises occur because of random noises and imperfect luminance/chrominance separation. In addition, some artificial color may be induced because the bandwidth of transmitted chrominance signal is limited.

Accordingly, there is a need for reducing color noises presenting in the color television systems.

### SUMMARY OF THE INVENTION

One aspect of the invention provides a method for reducing color noises of a chrominance signal. The method includes the following steps: receiving the chrominance signal; sampling the chrominance signal to generate a plurality of chrominance samples; determining a phase-rotation level between a specific chrominance sample and the chrominance samples; calculating an average value of the chrominance samples; and selectively outputting the average value or the chrominance information of the specific chrominance sample as an output chrominance information to represent the color information of the specific chrominance sample according to the phase-rotation level.

Another aspect of the invention provides an apparatus for reducing a color noise of the chrominance signal. The apparatus includes a sampling module, a phase-rotation level detection module, an average module and a chrominance output module. The sampling module samples the chrominance signal to generate a plurality of chrominance samples. The phase-rotation detection module receives the chrominance samples. And the phase-rotation detection module determines a phase-rotation level between a specific chrominance sample and the chrominance samples. The average module, connected with the sampling module, calculates an average value of the chrominance samples. The chrominance output module receives the average value and the specific chrominance sample. And the chrominance output module, according to the phase-rotation level, outputs an output chrominance information to represent the color information of the specific chrominance sample.

### BRIEF DESCRIPTION OF THE DRAWINGS

FIG. 1 illustrates a schematic diagram of a conventional separator.

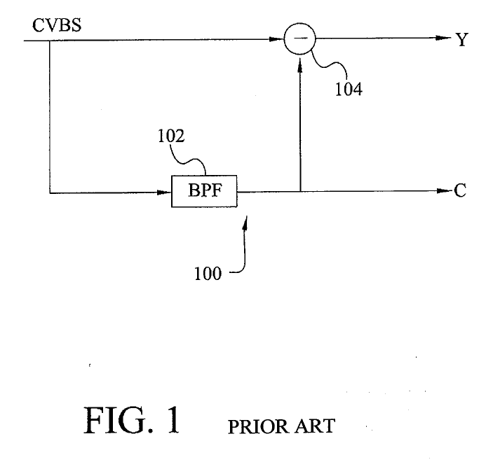

FIG. 2 illustrates an exemplary chrominance samples in scan lines of the NTSC system.

FIG. 3 illustrates an apparatus for reducing color noises on a chrominance signal.

FIG. 4 illustrates a flow chart of a method for reducing color noises on a chrominance signal.

### DETAILED DESCRIPTION

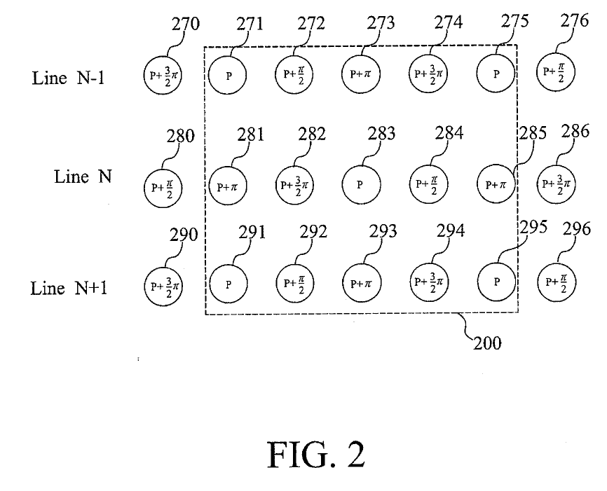

A method and an apparatus for reducing color noises are disclosed. In the following description, the invention can be further understood by referring to the exemplary, but not limiting, descriptions accompanied with the drawings from FIG. 2 to FIG. 4.

In one embodiment, the chrominance signal separated from the CVBS is sampled to generate a plurality of samples. The sampling frequency, for example, is set to be four times the sub-carrier frequency, i.e., 4ω. Each samples having chrominance information C represents color information of the sample. Because the sampling frequency is set to be four times the sub-carrier frequency, the chrominance information C of adjacent samples in a scan line ideally has a first phase shift there between. Moreover, the chrominance information C of adjacent samples between scan lines ideally has a second phase shift there between. For example, in NTSC system, the first phase shift refers to π/2, and the second phase shift refers to π. In another example, in PAL system, the first phase shift also refers to π/2, and the second phase shift refers to π/2.

Please refer to FIG. 2. FIG. 2 illustrates an exemplary chrominance samples (hereinafter referred to “sample(s)” for the sake of brevity) 270-276, 280-286, and 290-296 in a scan line (hereinafter referred to as line N) and adjacent scan lines (hereinafter referred to as line N−1 and line N+1) of the NTSC system. The chrominance information C of samples, for example, samples 270, 280 and 290, located in adjacent scan lines N−1, N and N+1 are phase-shifted with respect to each other by the second phase shift, i.e., π. The chrominance information C of samples 280˜286 in the scan line N are phase-shifted with respect to each other by the first phase shift, i.e., π/2. Similar to the scan line N, the chrominance information C of samples 270˜276 in scan line N−1 are phase-shifted with respect to each other by the first phase shift, i.e., π/2. And the chrominance information C of samples 290˜296 in scan line N+1 are phase-shifted with respect to each other by the first phase shift, i.e., π/2. Therefore, the chrominance information C of samples 271, 275, 283, 291 and 295 have the same phase, and those samples are grouped as a first group of chrominance samples denoted as P in FIG. 2. The chrominance information C of samples 272, 276, 280, 284, 292 and 296 has the same phase, and those samples are grouped as a second group of chrominance samples denoted as P+π/2 in FIG. 2. The chrominance information C of samples 273, 281, 285 and 293 has the same phase, and those samples are grouped as a third group of chrominance samples denoted as P+π in FIG. 2. The chrominance information C of samples 270, 274, 282, 286, 290 and 294 has the same phase, and those samples are grouped as a fourth group of chrominance samples denoted as P+(3π/2) in FIG. 2.

Therefore, in a region 200 of FIG. 2, the chrominance information C of a specific sample 283 ideally is in phase with that of the first group chrominance samples 271, 275, 291 and 295. And the chrominance information C of the specific sample 283 ideally is inverse-phase with that of the third group of chrominance samples 273, 281, 285 and 293.

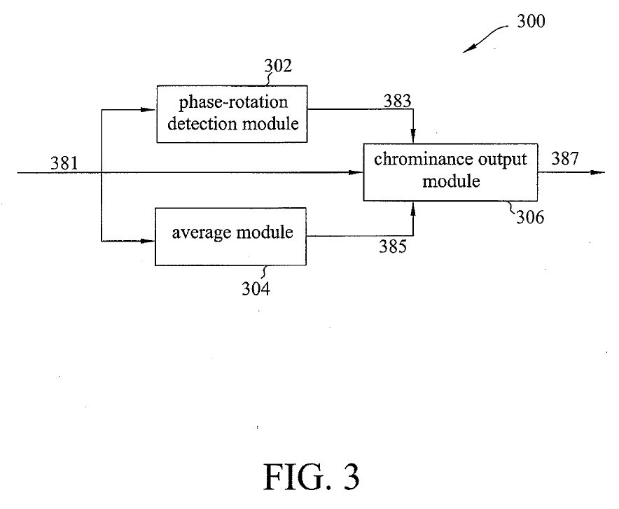

FIG. 3 illustrates an apparatus 300 for reducing color noises on a chrominance signal. The apparatus includes a sampling module (not shown), a phase-rotation detection module 302, an average module 304 and a chrominance output module 306. The sampling module samples the chrominance signal separated from the CVBS to generate a plurality of chrominance samples 381. The phase-rotation detection module 302 receives the chrominance samples 381 and determines a phase-rotation level 383 between a specific chrominance sample and the received chrominance samples 381. The specific chrominance sample may be one of the received chrominance samples 381. The average module 304 receives the chrominance samples 381 and calculates an average chrominance value 385 of the received chrominance samples 381. The chrominance output module 306 receives the specific chrominance sample 381, the phase-rotation level 383 and the average chrominance value 385. The chrominance output module 306, according to the phase-rotation level 383 and/or the average chrominance value 385, selectively outputs the chrominance information C of the specific chrominance sample, the average chrominance value 385 or a cored chrominance value as an output chrominance information 387 to represent the color information of the specific chrominance sample.

Please refer to FIG. 2 and FIG. 3. In one embodiment, in order to determine the chrominance information C of a specific chrominance sample, for example sample 283, in a scan line N, the apparatus 300 receives a plurality of the chrominance samples 271˜275, 281˜285, and 291˜295 in a region 200 of FIG. 2. The phase-rotation detection module 302 determines a phase-rotation level 383 between the specific chrominance sample 283 and the received chrominance samples 271˜275, 281˜285, and 291˜295. As describe above, ideally the chrominance information C of the specific chrominance sample 283 is in phase with that of chrominance samples 271, 275, 291 and 295. And chrominance information C of the specific chrominance sample 283 is inverse-phase with that of chrominance samples 273, 281, 285 and 293. The phase-rotation detection module 302 includes a phase comparator (not shown) and an adder (not shown). The phase comparator respectively compares the phases of the specific chrominance sample 283 with the chrominance samples 271˜275, 281˜285, and 291˜295 to generate a plurality of phase errors. Then the adder sums the phase errors to generate the phase-rotation level 383.

For example, when the compared chrominance samples belong to the same group, like chrominance samples 283 and 271, if the phase shift between two compared chrominance samples is smaller than 180 degree, the phase error is set to be “0”, otherwise the phase error is set to be “1”. When the compared chrominance samples belong to different groups, like chrominance samples 283 in the first group and the chrominance sample 273 in the third group, if the phase shift between two compared chrominance samples is smaller than 180 degree, the phase error is set to be “1”, otherwise the phase error is set to be “0”.

The average module 304 receives the chrominance samples 271˜275, 281˜285, and 291˜295 and calculates the average chrominance value 385 by averaging the chrominance information C of the received chrominance samples 271˜275, 281˜285, and 291˜295. Because that the phase of the chrominance information C of the first group of chrominance samples 271, 275, 283, 291, and 295 ideally is inverse to that of the third group of chrominance samples 273, 281, 285, and 293. Therefore, the average chrominance value 385 can be calculated by:

$$AVG\_C = \frac{( {\sum }_{i = 1}^{n} Ci - {\sum }_{j = 1}^{m} Cj )}{( n + m )}$$

Wherein AVG_C represents the average chrominance value 385, the C represents chrominance information C of a chrominance sample, “i” represents the first group of chrominance samples, and “j” represents the third group of chrominance samples. In current embodiment, in the region 200, the first group of chrominance samples has 5 samples, so the value of “n” equals to 5. In the region 200, the third group of chrominance samples has 4 samples, so the value of “m” equals to 4.

In one embodiment, the chrominance output module 306 receives the phase-rotation level 383, the average chrominance value 385 and the specific chrominance sample 283. The chrominance output module 306, according to the phase-rotation level 383, selectively outputs the chrominance information C of the specific chrominance sample or the average chrominance value 385 as an output chrominance information to represent the color information of the specific chrominance sample. For example, if the phase-rotation level 383 smaller than 4, the chrominance output module 306 outputs the original chrominance information C of the specific chrominance sample as an output chrominance information 387 to represent the color information of the specific chrominance sample. And if the phase-rotation level 383 is greater than and equal to 4, the chrominance output module 306 outputs the average chrominance value 385 as an output chrominance information 387 to represent the color information of the specific chrominance sample.

In another embodiment, the invention applies various coring levels to the average chrominance value according to the phase-rotation level. More specifically, the average chrominance value could be cored with a large coring factor when the phase-rotation level is small, and the average chrominance value could be cored with a small coring factor when the phase-rotation level is large. That is because the phase-rotation level could serve as an indicator for the color noises. If the phase-rotation level is large, the chrominance information C of the specific chrominance sample is undependable, so that the average chrominance value is cored with a small coring factor. The chrominance output module 306 includes a coring module (not shown) which generates a cored chrominance value by multiplying the average chrominance value 385 with a coring factor, for example (1−phase-rotation level/8).

Therefore, if the phase-rotation level 383 smaller than a first threshold, e.g., 2, the chrominance output module 306 outputs the original chrominance information of the specific chrominance sample as an output chrominance information 387. And if the phase-rotation level 383 is greater than a second threshold, e.g., 6, the chrominance output module 306 outputs the average chrominance value as an output chrominance information 387. Otherwise, if the phase-rotation level 383 is greater than the first threshold and is smaller than the second threshold, the chrominance output module 306 outputs the cored chrominance value as an output chrominance information 387.

In another embodiment, if the average chrominance value 385 is quite small, e.g., less than 1% of a full range resolution, and if the phase-rotation level 383 is greater than a threshold, the chrominance output module 306 outputs zero level information as an output chrominance information 387 to represent that the specific chrominance sample has no color information. In an embodiment, for example, the full range resolution is 10 bits, i.e., chrominance value ranges from 0 to 1023, if the average chrominance value is less than 10, and if the phase-rotation level 383 is greater than a threshold, e.g., 5, the chrominance output module 306 outputs zero level information as an output chrominance information.

The exemplary embodiments as described above that is shown for illustrating the invention, and is not intended to limit the invention in any way. In another embodiment, the numbers of the chrominance samples in the region for determining the color information of the specific chrominance sample could be varied according the design requirement decided by a person of skilled in the art. And the region could be selected not only in the same frame but also in various frames, e.g., frames in a spatial domain or in a time domain.

In another embodiment, since the chrominance information C of the chrominance samples in the region has fixed phase shift. A person of skilled in the art could generate the phase-rotation level (like comparing phase shift with respect to various groups of samples), the average chrominance value (like average of absolute value of each chrominance sample) and the cored chrominance values by various ways. Therefore, the algorithm for coring chrominance level and selectively outputting the output chrominance information could be implemented accordingly.

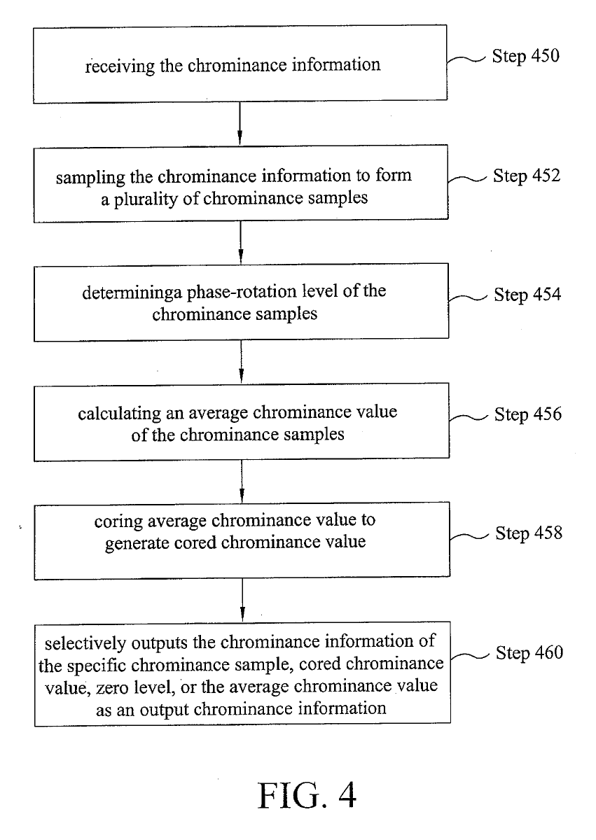

Please refer to FIG. 4. FIG. 4 illustrates a flow chart of a method for reducing color noises on a chrominance signal. The method of the invention includes the following steps: receiving the chrominance information C which is extracted from the CVBS (step 450); sampling the chrominance information C to form a plurality of chrominance samples (step 452); determining a phase-rotation level of the chrominance samples (step 454); calculating an average chrominance value of the chrominance samples (step 456); coring the average chrominance value with a coring factor to generate a cored chrominance value according to the phase-rotation level (step 458); and selectively outputs the chrominance C of a specific chrominance sample, the average chrominance value, zero level or a cored chrominance value as an output chrominance information as an output chrominance information to represent the color information of the specific chrominance sample, according to the phase-rotation level and the average chrominance value (step 460).

The invention has been described above with reference to preferred embodiments. However, those skilled in the art will understand that the scope of the invention need not be limited to the disclosed preferred embodiments. On the contrary, it is intended to cover various modifications and equivalent arrangements within the scope defined in the following appended claims. The scope of the claims should be accorded the broadest interpretation so as to encompass all such modifications and equivalent arrangements.

What is claimed is:

1. A method for reducing color noises of a chrominance signal, the method comprising the following steps:
(a) receiving the chrominance signal;
(b) sampling the chrominance signal to generate a plurality of chrominance samples;
(c) determining a phase-rotation level between a specific chrominance sample and the chrominance samples;
(d) calculating an average value of the chrominance samples; and
(e) selectively outputting the average value or the chrominance information of the specific chrominance sample as an output chrominance information to represent the color information of the specific chrominance sample according to the phase-rotation level.

2. The method of claim 1, wherein the specific chrominance sample is one of the chrominance samples generated in step (b).

3. The method of claim 1 further comprising coring the average value with a coring factor to generate a cored chrominance value.

4. The method of claim 3, wherein the coring factor is determined according to the phase-rotation level.

5. The method of claim 3, wherein the step (d) further comprises, according to the phase-rotation level, outputting the cored chrominance value as the output chrominance information to represent the color information of the specific chrominance sample.

6. The method of claim 1, wherein the step (c) further compresses:
respectively comparing the phase of the specific chrominance sample with the chrominance samples to generate a plurality of phase errors; and
summing the phase errors to generate the phase-rotation level corresponding to the specific chrominance sample.

7. The method of claim 1, wherein the step (d) further comprises, according to the phase-rotation level and the average chrominance value, outputting a zero level as the output chrominance information to represent that the specific chrominance sample has no color information.

8. An apparatus for reducing color noises of a chrominance signal, comprising:
a sampling module for sampling the chrominance signal to generate a plurality of chrominance samples;
a phase-rotation detection module for receiving the chrominance samples and determining a phase-rotation level between a specific chrominance sample and the chrominance samples;
an average module, connected with the sampling module, for calculating an average value of the chrominance samples; and
a chrominance output module for receiving the average value and the specific chrominance sample; wherein the chrominance output module, according to the phase-rotation level, outputs an output chrominance information to represent the color information of the specific chrominance sample.

9. The apparatus of claim 8, wherein the specific chrominance sample is one of the chrominance samples generated by the sampling module.

10. The apparatus of claim 8, wherein the chrominance output module further comprises a coring module for coring the average value with a coring factor to generate a cored chrominance value.

11. The apparatus of claim 10, wherein the coring factor is determined according to the phase-rotation level.

12. The apparatus of claim 10, wherein the chrominance output module, according to the phase-rotation level, outputs the cored chrominance value as the output chrominance information to represent the color information of the specific chrominance sample.

13. The apparatus of claim 8, wherein the phase-rotation detection module further comprises:
a phase comparator for respectively comparing the phase of the specific chrominance sample with the chrominance samples to generate a plurality of phase errors; and
an adder for summing the phase errors to generate the phase-rotation level corresponding to the specific chrominance sample.

14. The apparatus of claim 8, wherein the chrominance output module further, according to the phase-rotation level and the average chrominance value, outputs a zero level as the output chrominance information to represent that the specific chrominance sample has no color information.
